(19) United States
(12) Patent Application Publication
(10) Pub. No.: US 2007/0041517 A1
(43) Pub. Date: Feb. 22, 2007

(54) CALL TRANSFER DETECTION METHOD USING VOICE IDENTIFICATION TECHNIQUES

(75) Inventors: David CLARKE, Kanata, ON (CA); James A. PINARD, Dunrobin, ON (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(73) Assignee: PIKA TECHNOLOGIES INC., Kanata (CA)

(21) Appl. No.: 11/427,850

(22) Filed: Jun. 30, 2006

Related U.S. Application Data
(60) Provisional application No. 60/694,990, filed on Jun. 30, 2005.

(51) Int. Cl. H04M 1/64

(52) U.S. Cl. 379/67.1; 379/88.01

(57) ABSTRACT

A system and method for call handling make use of voiceprinting techniques to identify parties on the call and then allow call functions to be performed in accordance with the identified parties. These systems and methods can be used in conjunction with known call analysis and blocking techniques to reduce the likelihood that a caller from a restricted environment can connect to an unauthorized party by calling an authorized number and then having the call redirected, conferenced or otherwise transferred to the unauthorized party.

### CROSS REFERENCE TO RELATED APPLICATIONS

This application claims the benefit of priority of U.S. Provisional Patent Application No. 60/694,990 filed Jun. 30, 2005, which is incorporated herein by reference.

### FIELD OF THE INVENTION

The present invention relates generally to application of call functions based on audio patterns. More particularly, the present invention relates to applying call functions, such as recording, monitoring or terminating calls based on the identification of a voice pattern.

### BACKGROUND OF THE INVENTION

In many environments, telephone communication is restricted and monitored. In environments, such as correction facilities, individual access to a telephone is limited on a time basis, and restrictions are often placed on the numbers that an individual is permitted to call. Other environments where telephone access is restricted include research and military facilities. The following discussion uses correctional facilities as an exemplary situation, but the discussion should not be considered as limiting to that environment. Research facilities and other secure environments often restrict employee telephone access in much the same way that correctional facilities restriction prisoner/inmate telephone access.

These restrictions allow correctional facility administration to prevent an incarcerated individual from continuing existing, or instigating new, criminal activities by calling associates. Conventionally, the mechanism for doing this has required establishing a list of acceptable numbers for an inmate to call. The phones are then restricted to calling those numbers only when the inmate is placing a call.

Due to both privacy issues and the manpower involved, it is difficult to monitor whether or not the call has connected the inmate to the person that is supposed to be called, or if the call has been rerouted to another party. Rerouting of calls can be performed in a number of ways. One way is for the recipient of the call to make use of three-way calling features to simply connect another party of the call. This can be done after the call has been placed to the correctional facility, or can be performed in advance. Another less technically sophisticated method, is more difficult to detect, and simply requires that the third party to whom the call should be redirected to be present when the call is received so that the receiver can be passed along.

To address the first method of bridging calls, several technologies have been developed to detect ‘clicks’ generated by connecting calls. However, there are a number of services that allow a party to connect to a first party and then to bridge another caller into the call upon receipt of a call. Thus, an inmate can call his house where his wife has already commenced a call with a criminal associate and can be bridged into the call without generating the same tone sequence that is commonly associated with receipt of a call from the inmate and subsequent connection to another party. Furthermore, with the rise of Internet telephony, the party bridging the call can connect parties into a call without necessarily generating the conventional clicks. Click detect can generally be used for “plain old telephone service”. A click is an audio artifact heard at the near end that results from the edges of a DC transition (On hook, Hook flash, rotary pulse dialing) that occurs at the far end of a telephone connection. The click detect technique involves in-band audio processing to detect audible clicking artifact sounds made by the far end telephone hook switch during a hook flash, which is the momentary on hook (100 to 500 milliseconds) signal used on analog phone lines to indicate the start of a feature access code such as CALL HOLD, Three-way call etc. This method suffers from voice simulation of clicks during talking states and variable network, line and phone characteristics and does not work reliably for IP or PBX based telephones.

The second method of connecting an unauthorized party is far more difficult to detect. The prisoner places a call to a number associated with an authorized individual, such as a spouse, a child, or a lawyer, and then has that individual hand the receiver (or the cellular phone) to the unauthorized party. This generates no tones or other telltale signs of the calling rules being violated.

Calls from a correctional facility, or other secure environment, can easily be monitored to determine numbers being called, because many facilities make use of a private branch exchange (PBX) system. This allows a fair amount of service customization, and permits administrators to block calls being made to certain individuals on a “black list”. People on this black list are typically prosecuting lawyers, judges and individuals on parole boards. Calls are prevented from being placed to these individuals to prevent threats from being made and bribes from being offered. Prison PBX systems are often set up with either a black list of numbers that inmates are not permitted to call, or can be set up to allow only white listed numbers (numbers on an expressly permitted list). The implementation of these list systems can be fine-tuned to create different black or white lists for each inmate, or can be generic to all inmates.

However, conventional black and while list systems are based on the assumption that phone numbers are tied to identity, and do not prevent third party call transfers (using either conference call or three-way calling, or even more simply using call forwarding)/ Preventing such transfers requires a system that detects the tell tale signatures of these systems and then terminates the call upon detection. As noted above, with the rise of data based telephony, such as Internet telephony, the conventional detection methods do not always work. Human monitoring of the lines is not permitted due to privacy concerns, and the right of the inmate to discuss matters with a lawyer without supervision.

Another call transfer detection technique includes detecting background noise level changes. Changes in line noise levels are detected during and after a transfer. This typically involves in-band (300 Hz to 3300 Hz) audio processing to monitor the line for a change of incoming background noise during a three way call attempt. This method is highly dependant on the noise characteristics of the lines and connection, and suffers from reliability problems.

A further method involves detection of echo of narrow band noise. Echo is an artifact of a transmitted audio signal that has returned after reflecting off various 2-to-4-wire connection points. 2-to-4 wire connection points occur during transitions to or from analog systems that do not employ distinct send and receive wires. The echo signal may be distorted relative to the original transmission in time, phase amplitude and spectrum. Detection of changes in the connection's echo characteristics during and after a transfer can be done. Typically done by adding a narrow band noise signal to the outbound audio, and measures changes in the echo of the narrow band signal from the far end during and after a three-way call attempt. This method is fairly reliable, but is expensive and tends to degrade the audio quality of a connection as the required power spectral density of the narrow band noise results in an obtrusive signal.

As noted above, these techniques cannot distinguish between phone numbers and call party identities. Furthermore, they are not reliable in view of advances in IP based telephony, which introduces artifacts of digitization that often confuse in-band audio processing techniques.

Thus, it would be desirable to offer a system that can detect unauthorized callers when they have been connected to a call.

### SUMMARY OF THE INVENTION

It is an object of the present invention to obviate or mitigate at least one disadvantage of previous call handling systems.

In a first aspect of the present invention, there is provided a method of telephone call handling. The method comprises the steps of analyzing an audio signal from a telephone call to extract a voiceprint from at least one party on the telephone call; determining the identity of the at least one party in accordance with the voiceprint and a set of previously obtained voiceprint-identity matchings; and performing a call function in accordance with the determined identity.

In embodiments of the present invention, the step of determining the identity of the party includes comparing the extracted voiceprint to a database of known voiceprints to obtain an identity, the identity can be an individual identity or can indicate membership in a list such as a blacklist or a whitelist, or can indicate lack of membership in a maintained list. In other embodiments, the step of analyzing includes identifying a plurality of voiceprints and the step of determining the identity includes determining an identity for each of the plurality of identified voiceprints, and the step of performing a call function can include selecting a call function in accordance with each of the determined identities. In a further embodiment, the step of performing a call function includes taking an action selected from a list including allowing the call to continue, logging the call, terminating the call, recording the call, initiating live call monitoring and alerting an administrator. In further embodiments, the method includes the step of receiving an inbound call in advance of the step of analyzing an audio signal, and the step of analyzing can include requesting that the calling party repeat a predetermined phrase and extracting a voiceprint on the basis of the repeated phrase, and where the step of performing a call function can include selecting a call function in accordance with the determined identity and the inbound calling phone number. In a further embodiment, the method includes the step of initiating a call to a provided telephone number in advance of the step of analyzing, where the step of performing a call function can include selecting a call function in accordance with the determined identity and the provided telephone number.

In a second aspect of the present invention, there is provided a system for handling calls. The system comprises a voiceprint analyzer, an identity database and a call function module. The voiceprint analyzer receives an audio signal from a telephone call and extracts voiceprints from the audio signal. The identity database stores voiceprint-identity pairings. The call function module receives at least one extracted voiceprint from the voiceprint analyzer, determines the identity of at least one call participant in accordance with the at least one extracted voiceprint and the voiceprint-identity pairings in the identity database, and selects a call function in accordance with the determined identity of the at least one call participant.

In embodiments of the second aspect of the present invention, the call function module includes an external interface for receiving a telephone number associated with the telephone call, and optionally the voiceprint analyzer includes means to extract a plurality of voiceprints from the audio signal and the call function module includes means for receiving the plurality of extracted voiceprints, and for determining an identity associated with each of the plurality of extracted voiceprints. In another embodiment of the present invention, the call function module includes means for selecting a call function in accordance with the plurality of determined identities. In further embodiments, the call function module includes means to select a call function from a list including allowing the call to continue, logging the call, terminating the call, recording the call, initiating live call monitoring and alerting an administrator. In further embodiments, the system includes means for executing the call function selected by the call function module.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a flowchart illustrating a method of identifying blacklisted call parties;

FIG. 2 is a flowchart illustrating a method of identifying whitelisted call parties;

FIG. 3 is a flowchart illustrating a method of identifying blacklisted call parties, whitelisted call parties, and greylisted call parties;

FIG. 4 is a flowchart illustrating a method of handling outbound calls using voiceprint analysis;

FIG. 5 is a flowchart illustrating a method of handling an inbound call using voiceprint analysis;

FIG. 6 is a flowchart illustrating a method of call handling using voiceprint analysis; and

FIG. 7 is a block diagram illustrating a system for detecting call parties using voiceprint analysis.

### DETAILED DESCRIPTION

Generally, the present invention provides a method and system for call processing and handling in a restricted environment.

In the following description, for purposes of explanation, numerous details are set forth in order to provide a thorough understanding of the present invention. However, it will be apparent to one skilled in the art that these specific details are not required in order to practice the present invention. In other instances, well-known electrical structures and circuits are shown in block diagram form in order not to obscure the present invention. For example, specific details are not provided as to whether the embodiments of the invention described herein are implemented as a software routine, hardware circuit, firmware, or a combination thereof. Although the following discussion makes exemplary reference to application of the present invention in correctional facility environments, this should not be taken as limiting or restricting in any way. The methods and systems of the present invention can be employed in any environment where telephone communication is to be restricted such as research and other secure facilities.

Human voices are known to have identifying characteristics forming a voiceprint that can be thought of as roughly analogous to a fingerprint. Although there is no guarantee that the voiceprint of two people will be different, there is an incredibly high statistical likelihood that this will be the case. Voice printing technologies are known in the art, and have become feasible to employ on a real-time basis due the advancements in computing power available.

U.S. Pat. No. 6,493,668, entitled “Speech feature extraction system”, the contents of which are incorporated herein by reference, describes how features related to the frequency and amplitude characteristics of an input speech signal can be extracted in real time. U.S. Pat. No. 6,799,163, entitled “Biometric Identification System”, the contents of which are incorporated herein by reference, describes how voice identification can be used to determine when a change of speaker has occurred. These references, along with other known speech processing systems such as FreeSpeech, by PerSay (see e.g. http://www.persay.com/freeSpeech.asp) an OEM Biometric Speaker Verification technology that verifies speakers in the background of a natural conversation, can be employed in a system of the present invention to provide call transfer detection based on identity and not telephone numbers.

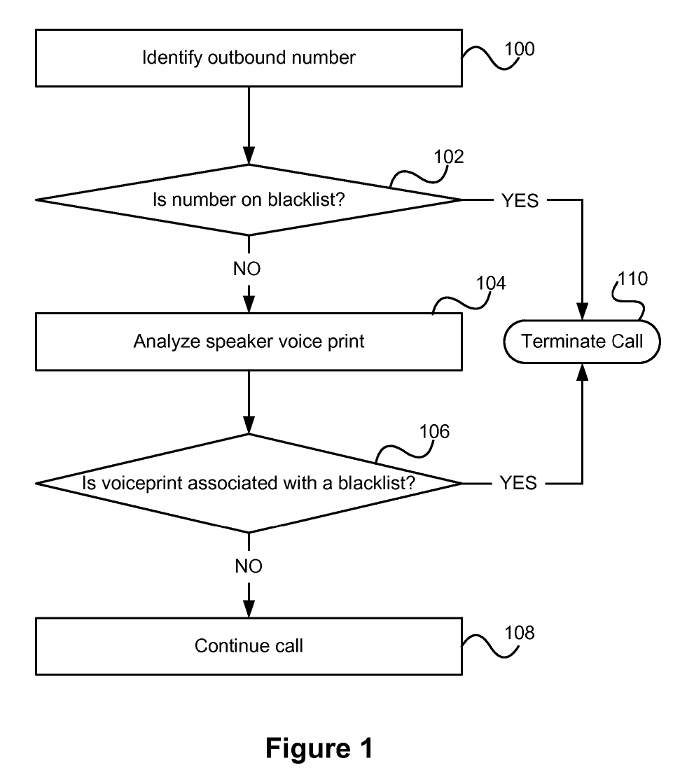

The present invention allows a series of different decisions to be made on the basis of a voice print analysis. It can also be combined with existing telephone number based blocking (although it is not necessary to do so) as evidenced by the method illustrated in the flowchart of FIG. 1.

In step 100 an outbound telephone number is identified. Those skilled in the art will appreciate that this can be implemented using any of a number of known techniques including an analysis of the dual tone multiple frequency (DTMF) signals generated. This number is then examined to determine whether or not it is on a blacklist in step 102. If the number is on a blacklist the call is terminated in step 110, preferably before connection to the outside party. If the number is not on the blacklist, the call is connected to the dialed number, and upon connection a voiceprint analysis is performed in step 104. A determination of whether or not the voiceprint is associated with an individual on a blacklist is made in step 106. If the speaker is not on the blacklist, the call is continued in step 108. If the speaker is on the blacklist, the call is terminated in step 110.

The termination of calls can prevent an incarcerated individual from being connected to individuals who can facilitate a further criminal venture, or who may be the subject of either bribery of threats.

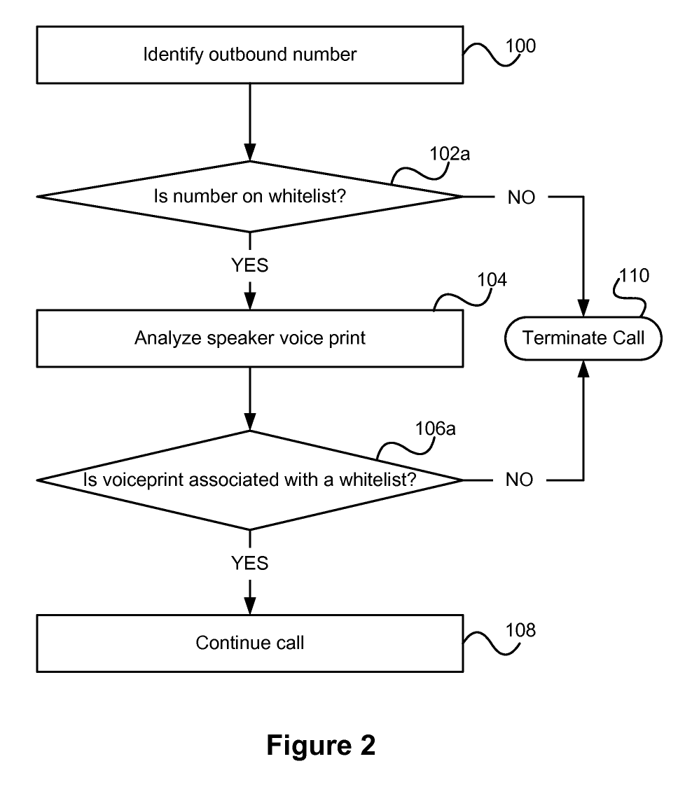

A similar system can be employed making use of a whitelist. The whitelist specifies numbers and voiceprints that are permitted, as opposed to specifying numbers and voiceprints that are not permitted. A method implementing a whitelist is illustrated in the flowchart of FIG. 2. As before, an outbound telephone number is identified in step 100. In step 102a a determination is made as to whether or not the number is on the whitelist. If the number is not on the whitelist the call is terminated in step 110. If the number is on a whitelist the call is connected and voiceprint analysis is performed in step 104. In step 106a a determination is made as to whether or not the voiceprint is associated with entries on the whitelist. If the voiceprint is not on the whitelist, the call is terminated in step 110, but if the voiceprint is on the whitelist, the call is continued in step 108.

The black and white lists are typically specific to an incarcerated individual, but can share common elements with other maintained lists. This allows the creation of a master blacklist, where each individual's black list would be a combination of the master blacklist and an individual blacklist.

Whereas prior art systems attempt to cut off calls when detection of an attempt to connect in a third party is made, the system of the present invention can discriminate between allowed numbers and unallowed persons. Thus, the numbers on either a whitelist or a blacklist do not necessarily correspond to the voiceprints allowed. An outbound number black list can also be combined with a caller whitelist, and vice versa. Furthermore, the concept of a grey list can also now be introduced.

Whereas prior art embodiments either permitted certain calls (whitelist) or forbade certain calls (blacklist), the present invention allows the use of both system, and permits speakers and numbers that do not appear in either list to be treated differently than they would be in either case.

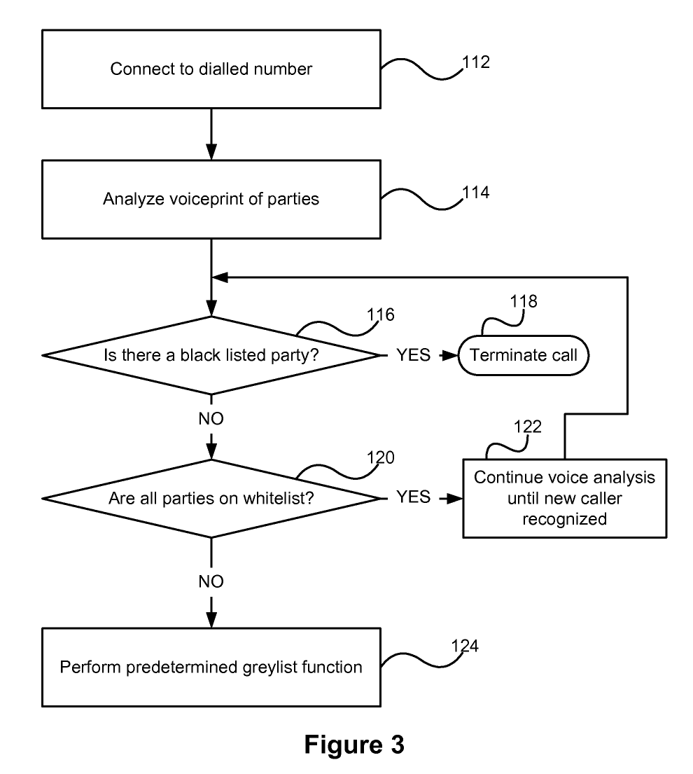

FIG. 3 illustrates a method of the present invention making use of greylist functionality. In step 112 a connection is made to a dialed number. One skilled in the art will appreciate that prior to this step call blocking may have been employed. In step 114 an analysis of the voiceprints of the callers is performed. In step 116 the voiceprints are compared to entries on a blacklist. If one of the parties on the call is on the blacklist, the call is terminated in step 118. If none of the parties is on the blacklist, a determination is made as to whether or not all the callers appear on a whitelist in step 120. If all the callers are on the whitelist, the call is continued in step 122 until a new voiceprint is identified and the process returns to step 116. If a party on the call is not identified as being part of a whitelist, then that party is on neither the whitelist nor the blacklist, and greylist procedures are employed in step 124.

Greylist procedures can include allowing a call to proceed without impediment, recording the call for later analysis, signaling an administrator so that live monitoring of the call can be made, termination of the call and other procedures that will be apparent to those skilled in the art and may include employing computerized real-time speech analysis to scan for selected words. If such words occur, calls may be recorded, terminated, or subject to other actions.

One skilled in the art will appreciate that the decisions made regarding white, black and grey listed parties can be made in different orders, and can also be made simultaneously without departing from the scope of the present invention. Furthermore, voiceprint lists can be variable, so that they are selected in accordance with both the call originator and the number called. This would permit someone to phone a lawyer at an office number, but could forbid calls to the lawyer if either another party was dialed. Alternatively, it may not be permitted to record calls between an inmate an a lawyer, but if the voiceprint of another individual is recognized, the call may be recorded to determine if the call was about legal matters or if the lawyer was participating in a criminal venture.

Whereas prior art systems relied upon the use of strict permission lists, the introduction of greylisting allows the system greater flexibility in handling call functions, such as call termination, call logging, permitting the call to continue, call recording, notification of an administrative entity and call monitoring. The use of voiceprinting along with greylisting allows for individualized action as opposed to action based on telephone numbers.

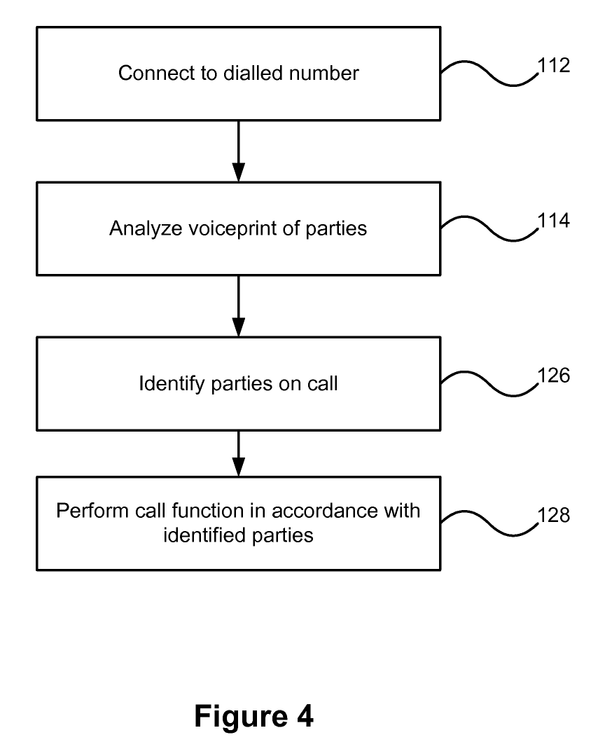

FIG. 4 illustrates an exemplary flowchart of a method of the present invention. As before, in steps 112 and 114 the dialed number is connected to, and analysis of the voiceprints is performed. The parties on the call are identified on the basis of the voiceprint in step 126. These identities can be matched to either whitelists or blacklists, and parties can be identified as unknown. On the basis of the identification, call functions as described above can be performed. As the call functions are based on the identification of a party on the call, it is possible to individually tailor call functions to different individuals. Furthermore, if more than one party is recognized, the call handling can be varied based on the combination of parties. This provides greater granularity for telephone system administrators, and allows flexibility based on changing circumstances.

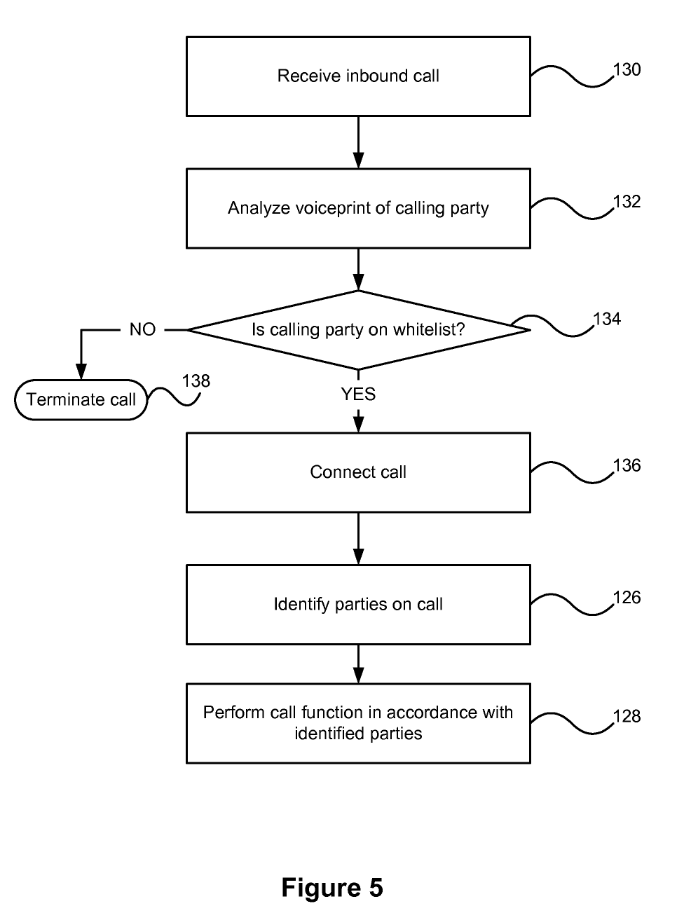

A methodology can be employed to screen inbound calls. Whereas inbound calling has conventionally been screen on the basis of a whitelist of acceptable numbers, inbound calls can now be screened on the basis of a voiceprint. This allows correctional facilities to allow inbound callers to connect to prisoners if they are on a whitelist. This whitelist, being based on voiceprints, can be made to be telephone number agnostic, or can be implemented in addition to a telephone number screening process. FIG. 5 illustrates an exemplary method of handling inbound calls. In step 130 a call is received. In step 132 the voiceprint of the calling party is identified. In step 134 the voiceprint is compared to a whitelist. If the calling party is not on the whitelist, the call is terminated in step 138. If the calling party is on the whitelist the call is connected in step 136. During the call, steps 126 and 128 are performed so that new parties added at the calling end are detected and appropriate action is taken in accordance with the determined identity of the new parties.

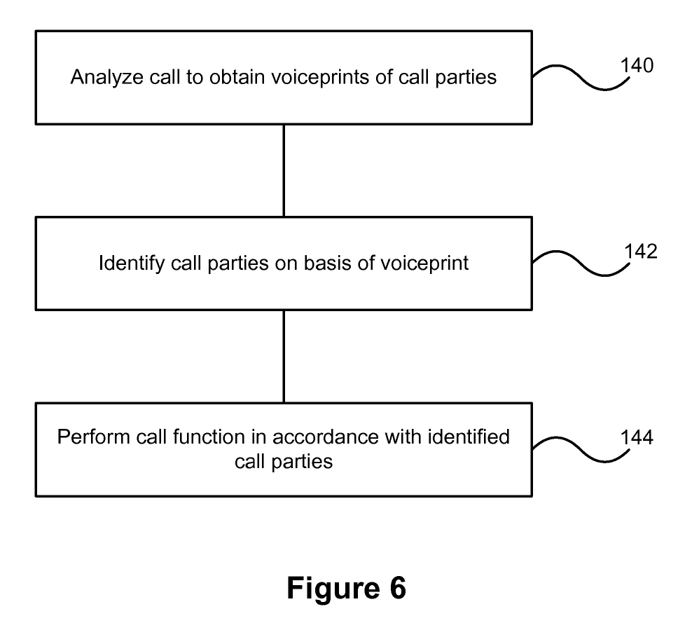

FIG. 6 illustrates a method of analyzing calls applicable to both inbound and outbound calls. In step 140, voiceprint analysis is performed to determine a voiceprint for all parties on the call. In step 142, the call parties are identified on the basis of the determined voiceprint. In step 144, call functions, such as call termination, recording, monitoring and allowing the call to proceed, are taken in accordance with the identities of the call parties. As noted above, combinations of different call parties can result in different call functions being executed.

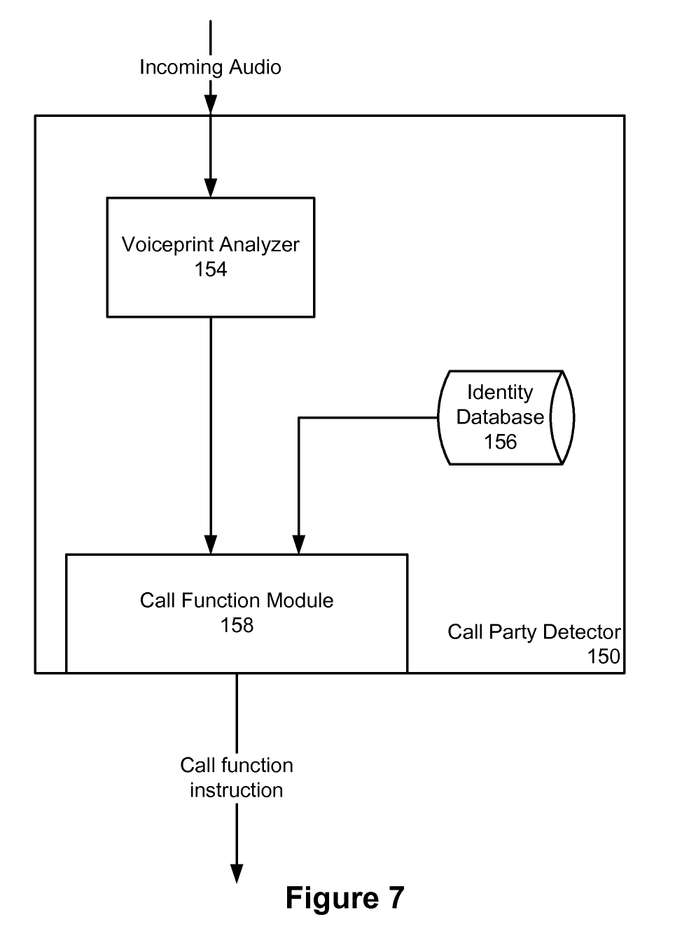

FIG. 7 illustrates a system for executing the method of the present invention. One skilled in the art will appreciate that the system can be installed as a standalone call processing system, or can be built into telephone systems such as PBX systems to provide greater integration where possible.

Call party detector 150 receives audio signals from a call. The audio signals are provided to a voiceprint analyzer 154. The voiceprint analyzer 154 extracts voiceprints from the received audio signals and provides them to call function module 158. Call function module 158 receives the voiceprints, and in conjunction with identity database 158 determines the identity of the calling party and provides as an output a call function instruction determined in accordance with the identity of the call parties.

One skilled in the art will appreciate that the call party identity can be very specific, so that it identifies a particular individual, or can be generic so that people are identified as being a part of the white list, the black list or as being part of neither list. The call function module 158 can determine the inmate on the call on the basis of either an external information feed (not shown) or through voice print analysis of the parties on the call.

One skilled in the art will appreciate that the above-described methods can all be executed on the system illustrated in FIG. 7. The analysis of voiceprints can continue past the initial stages of a call so that parties joining in at a later point can be identified and appropriate action can be taken.

In one embodiment, to facilitate ease of voiceprinting, call parties are asked to either state their name or repeat a phrase, while isolated from the other call parties. This reduces the amount of background noise and permits a simplified voice printing process. Continual monitoring of the call allows the system to determine if an unrecognized voiceprint is present. At that time the voiceprint can either be determined through conversation, or the call can be interrupted and a call party can be asked for voice identification.

It should be noted that although the above discussion has been presented in the context of being implemented in a correctional institution, the system and method could easily be implemented in other secure environments where restrictions on telephone contact are enforced including research and military facilities.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of telephone call handling comprising:
analyzing an audio signal from a telephone call to extract a voiceprint from at least one party on the telephone call;
determining the identity of the at least one party in accordance with the voiceprint and a set of previously obtained voiceprint-identity matchings; and
performing a call function in accordance with the determined identity.

2. The method of claim 1 where the step of determining the identity of the party includes comparing the extracted voiceprint to a database of known voiceprints to obtain an identity.

3. The method of claim 1 wherein the step of determining the identity includes identifying the party as belonging to a blacklist.

4. The method of claim 1 wherein the step of determining the identity includes identifying the party as belonging to a whitelist.

5. The method of claim 1 wherein the step of determining the identity includes identifying the party as belonging to neither a blacklist nor a whitelist.

6. The method of claim 1 wherein:
the step of analyzing includes identifying a plurality of voiceprints; and
the step of determining the identity includes determining an identity for each of the plurality of identified voiceprints.

7. The method of claim 6 wherein the step of performing a call function includes selecting a call function in accordance with each of the determined identities.

8. The method of claim 1 wherein the step of performing a call function includes taking an action selected from a list including allowing the call to continue, logging the call, terminating the call, recording the call, initiating live call monitoring and alerting an administrator.

9. The method of claim 1 further including the step of receiving an inbound call in advance of the step of analyzing an audio signal.

10. The method of claim 9 wherein the step of analyzing includes requesting that the calling party repeat a predetermined phrase and extracting a voiceprint on the basis of the repeated phrase.

11. The method of claim 9 wherein the step of performing a call function includes selecting a call function in accordance with the determined identity and the inbound calling phone number

12. The method of claim 1 further including the step of initiating a call to a provided telephone number in advance of the step of analyzing.

13. The method of claim 12 wherein the step of performing a call function includes selecting a call function in accordance with the determined identity and the provided telephone number.

14. A system for handling calls comprising:
a voiceprint analyzer for receiving an audio signal from a telephone call and for extracting voiceprints from the audio signal;
an identity database for storing voiceprint-identity pairings; and
a call function module for receiving at least one extracted voiceprint from the voiceprint analyzer, for determining the identity of at least one call participant in accordance with the at least one extracted voiceprint and the voiceprint-identity pairings in the identity database, and for selecting a call function in accordance with the determined identity of the at least one call participant.

15. The system of claim 14 wherein the call function module includes an external interface for receiving a telephone number associated with the telephone call.

16. The system of claim 15 wherein
the voiceprint analyzer includes means to extract a plurality of voiceprints from the audio signal; and
the call function module includes means for receiving the plurality of extracted voiceprints, and for determining an identity associated with each of the plurality of extracted voiceprints.

17. The system of claim 14 wherein the call function module includes means for selecting a call function in accordance with the plurality of determined identities.

18. The system of claim 14 wherein the call function module includes means to select a call function from a list including allowing the call to continue, logging the call, terminating the call, recording the call, initiating live call monitoring and alerting an administrator.

19. The system of claim 14 further including means for executing the call function selected by the call function module.
